(19) United States
(12) Patent Application Publication
(10) Pub. No.: US 2015/0197839 A1
(43) Pub. Date: Jul. 16, 2015

(54) FORMING CONDUCTIVE PATTERN USING TITANIA SOL-GEL

(71) Applicant: Maria Celeste Rellamas Tria, Rochester, NY (US)

(72) Inventor: Maria Celeste Rellamas Tria, Rochester, NY (US)

(21) Appl. No.: 14/153,353

(22) Filed: Jan. 13, 2014

(51) Int. Cl. C23C 2/14; C09D 7/12

(52) U.S. Cl. CPC C23C 2/14; C09D 7/1233

(57) ABSTRACT

A conductive metal pattern is formed using a layer of a titania sol-gel formed from a titania precursor composition of (a) a titanium alkoxide or titanium aryloxide, (b) R(O)ₘCOCH₂CO(O)ₙR′ wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, to form a layer of a titania sol-gel on the substrate. The layer is contacted with electroless seed metal ions to provide a layer of electroless seed metal ions, imagewise exposed to form non-exposed regions and exposed regions. The electroless seed metal ions in the non-exposed regions are removed and the electroless seed metal nuclei within the titania sol-gel in the exposed regions are then electrolessly plated with a conductive metal.

### RELATED APPLICATION

Copending and commonly assigned U.S. Ser. No. 14/______ filed on even date herewith by myself and entitled “Use of Titania Precursor Composition Pattern” (Attorney Docket K001572/JLT).

### FIELD OF THE INVENTION

This invention relates to a titania precursor composition that can be used to provide a titania sol-gel that can reduce electroless seed metal ions that can then be electrolessly plated to form a conductive metal pattern. This invention also includes an electroless plating method in which the inventive titania precursor composition is used and various articles useful therein.

### BACKGROUND OF THE INVENTION

In recent decades accompanying rapid advances in information-oriented society, there have also been rapid technological advances to provide devices and systems for gathering and communicating information. Of these, display devices have been designed for television screens, commercial signage, personal and laptop computers, personal display devices, and phones of all types, to name the most common information sharing devices.

In display devices where a continuous conductive film is not practical for providing this protection from electromagnetic radiation emission, it has been found that conductive mesh or patterns can be used for electromagnetic wave shielding purpose

Other technologies have been developed to provide new microfabrication methods to provide metallic, two-dimensional, and three-dimensional structures with conductive metals. Patterns have been provided for these purposes using photolithography and imaging through mask materials.

Improvements have been proposed for providing conductive patterns using photosensitive silver salt compositions such as silver halide emulsions. Such techniques have a number of disadvantages that are described in the art and efforts continue to make additional improvements.

As the noted display devices have developed in recent years, their attraction has increased greatly with the use of touch screen technology whereby a light touch on the screen surface with a finger or stylus can create signals to cause changes in screen views or cause the reception or sending of information, telecommunications, interaction with the internet, and many other features that are being developed at an ever-increasing pace of innovation. The touch screen technology has been made possible largely by the use of transparent conductive grids on the primary display so that the location of the noted touch on the screen surface can be detected by appropriate electrical circuitry and software. For a number of years, touch screen displays have been prepared using indium tin oxide (ITO) coatings to create arrays of capacitive patterns or areas used to distinguish multiple point contacts. ITO can be readily patterned using known semiconductor fabrication methods including photolithography and high vacuum processing. However, the use of ITO coatings has a number of disadvantages. Indium is an expensive rare earth metal and is available in limited supply. Moreover, ITO is a ceramic material and is not easily bent or flexed and such coatings require expensive vacuum deposition methods and equipment. In addition, ITO conductivity is relatively low, requiring short line lengths to achieve desired response rates (upon touch). Touch screens used in large displays are broken up into smaller segments in order to reduce the conductive line length to an acceptable electrical resistance. These smaller segments require additional driving and sensing electronics, further adding to the cost of the devices.

Silver is an ideal conductor having conductivity that is 50 to 100 times greater than that of ITO. Unlike most metal oxides, silver oxide is still reasonably conductive and its use reduces the problem of making reliable electrical connections. Moreover, silver is used in many commercial applications and is available from numerous commercial sources.

In other technologies, transparent polymeric films have been treated with conductive metals such as silver, copper, nickel, and indium by such methods as sputtering, ion plating, ion beam assist, wet coating, as well as the vacuum deposition. However, all of these technologies are expensive, tedious, or extremely complicated so that the relevant industries are spending considerable resources to design improved means for forming conductive patterns for various devices especially touch screen displays.

U.S. Pat. No. 5,925,415 (Fry et al.) describes a method for electroless plating on a substrate surface having hydroxyl groups involving treatment with silyl hydride to form silicon hydroxide bonds, followed by deposition of silver ions, and electroless plating.

U.S. Patent Application Publication 2011/0117338 (Poquette et al.) describes electroless plating of open pore foam materials using tin or palladium catalysts.

U.S. Patent 2005/0133904 (Kim et al.) describes a method for forming multilayer pattern for hermetic sealing of packages by coating a titanate based photocatalytic compound to form a film, UV exposure, growing palladium catalysts, and electrolessly plating a metal.

Yan et al., Chem. Mater. 1995, 7, 2007-2009 describe the preparation of amorphous coatings using a composition of titanium alkoxide, acetoacetate, water, ethanol, propanol, and HCl on a porous silica substrate to provide differences in refractive index.

Tadanaga et al., Chem. Mater. 2000, 12, 590-592 describe the use of titanium alkoxide, acetoacetate, and water in a composition to form a superhydrophobic-superhydrophilic pattern on an alumina layer.

Stathatos et al. Langmuir 2000, 16, 2398-2400 describes photocatalytically depositing silver nanoparticles on mesoporous titanium dioxide films.

Despite the advances in the art to provide conductive metal patterns for various devices, it is very difficult to form very fine (thin) conductive lines on flexible films for electronic devices of all types. Catalytic seed materials must have significant durability to withstand electroless plating conditions and baths. Other problems are experienced with various known patterning materials and there remains a need to provide high strength, thin conductive lines.

### SUMMARY OF THE INVENTION

To address at least some of the problems described above, the present invention provides a method for forming a conductive metal pattern, comprising:

providing a layer of a titania sol-gel formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate,

contacting the layer of titania sol-gel with electroless seed metal ions to provide a layer of electroless seed metal ions within the layer of titania sol-gel on the substrate,

imagewise exposing the layer of electroless seed metal ions deposited within the layer of titania sol-gel to form non-exposed regions and exposed regions, the non-exposed regions comprising non-exposed electroless seed metal ions within the titania sol-gel, and the exposed regions comprising electroless seed metal nuclei within the titania sol-gel,

removing the electroless seed metal ions in the non-exposed regions, and

electrolessly plating the electroless seed metal nuclei within the titania sol-gel in the exposed regions using a metal that is the same as or different from the electroless seed metal nuclei.

The present invention also provides a precursor article comprising a substrate having a layer of a titania sol-gel that has been formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

Moreover, an intermediate article of the present invention comprises a substrate and having disposed thereon a layer of titania sol-gel, the layer of titania sol-gel comprising electroless seed metal ions within the titania sol-gel that has been formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

Another intermediate article of this invention comprises a substrate and having disposed thereon a layer of a titania sol-gel, the layer of titania sol-gel comprising exposed regions comprising electroless seed metal nuclei within the titania sol-gel, and non-exposed regions comprising corresponding electroless seed metal ions within the titania sol-gel,

wherein the layer of titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

Still another intermediate article of this invention comprises a substrate and having disposed thereon a layer of a titania sol-gel, the layer of titania sol-gel comprising exposed regions comprising electroless seed metal nuclei within the titania sol-gel, and non-exposed regions comprising only the titania sol-gel,

wherein the layer of titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

Further, a product article of this invention comprises a substrate and having disposed thereon a layer of a titania sol-gel, the layer of titania sol-gel comprising exposed regions comprising electrolessly plated metal within the titania sol-gel, and non-exposed regions comprising only the titania sol-gel,

wherein the titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

The method of the present invention provides conductive patterns with fine line features in an efficient manner. Once dried, the fine conductive lines are stable on a substrate and can exhibit good adhesion. These advantages can be achieved by forming a pattern of a conductive material using a titania precursor composition that reacts during exposure to suitable electromagnetic radiation (for example, UV radiation). The resulting titania sol-gel is stable in various baths used without the need of crosslinking agents or thermal curing, to form a pattern of conductive metal provided by electroless metal plating.

### DETAILED DESCRIPTION OF THE INVENTION

### Definitions

As used herein to define various components of the titania precursor compositions, unless otherwise indicated, the singular forms “a”, “an”, and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term definition should be taken from a standard dictionary.

The use of numerical values in the various ranges specified herein, unless otherwise expressly indicated otherwise, are considered to be approximations as though the minimum and maximum values within the stated ranges were both preceded by the word “about”. In this manner, slight variations above and below the stated ranges can be used to achieve substantially the same results as the values within the ranges. In addition, the disclosure of these ranges is intended as a continuous range including every value between the minimum and maximum values.

Average dimensions such as average width, average depth, and average height of relief images, conductive lines, or dried lines or layers or titania precursor composition, can be determined by measuring the feature in at least 10 different places using known measurement techniques, and determining the average from those at least 10 measurements.

### Uses

The titania precursor compositions used in the present invention can be used to provide conductive metal patterns that can be incorporated into various devices including but not limited to touch screen or other display devices that can be used in numerous industrial and commercial products.

For example, the present invention can be used to prepare conductive articles including capacitive touch sensors that can be incorporated into electronic devices with touch-sensitive features. These electronic devices include but are not limited to computing devices, computer displays, portable media players including e-readers, mobile telephones and other communicating devices, televisions, computer monitors, and projectors. Display devices can be used to display images, text, graphics, video images, movies, still images and presentations.

### Titania Precursor Compositions

The titania precursor compositions useful in the present invention are composed of five essential components in suitable molar amounts sufficient, upon drying, to form a titania sol-gel (as a layer or pattern) on a substrate. This dried titania sol-gel would comprise predominantly three of the essential components as most or all of the water and water-miscible organic solvents would have been removed during drying. However, some water would likely be incorporated in the titania sol-gel network as a part of the reaction from which it is formed. The water provides H⁺ that combines with the hydrolyzable groups of the titanium alkoxide or titanium aryloxide to produce alcohols (for example, reaction of isopropoxide to form isopropanol) as by-products as the titania sol-gel is formed.

Component (a): Titanium Alkoxide or Titanium Aryloxide

A first essential component is a titanium alkoxide or titanium aryloxide. Mixtures of titanium alkoxides, mixtures of titanium aryloxides, or mixtures of both titanium alkoxides and titanium aryloxides can be used if desired. In general, these compounds comprise one or more titanium atoms and multiple (two or more) alkoxides, aryloxides, or both alkoxides and aryloxides in each molecule. In addition, the titanium alkoxides and titanium aryloxides useful in the present invention can comprise multiple (two or more) titanium atoms in each molecule.

These multi-titanium alkoxide or aryloxide molecules can be represented by:

(Ti)_{y}(OR¹)ₓ

wherein x is an integer of at least 2 and can be from 2 and up to and including 4, and y is an integer of at least 2 and can be from 2 and up to and including 4.

The two or more R¹ groups are the same or different substituted or unsubstituted alkyl groups or substituted or unsubstituted aryl groups. Useful substituted or unsubstituted alkyl groups in the alkoxide groups can be linear or branched, cyclic or acyclic, and comprise at least 1 and up to and including 20 carbon atoms, and typically at least 1 and up to and including 4 carbon atoms. Representative substituted or unsubstituted alkyl groups include but are not limited to methyl, ethyl, n-propyl, isopropyl, t-butyl, n-hexyl, cyclopentyl, and cyclohexyl to form the corresponding alkoxide groups. Other particularly useful alkyl groups are substituted or unsubstituted alkyl ethers of ethylene and diethylene glycols including alkyl ethers such as monomethyl ether, monoethyl ether, monopropyl ether, monoisopropyl ether, monobutyl ether, monophenyl ether, and monobenzyl ether that form the corresponding alkoxide groups. Esters of ethylene glycol and diethylene glycol are also useful in present invention. As noted above, the R¹ groups in the compound can include two or more different substituted or unsubstituted alkyl groups in two or more substituted or unsubstituted alkoxide groups, such as a combination of alkyl groups and alkyl ether groups to form different alkoxide groups.

In most embodiments, the titanium alkoxide comprises the same alkoxide groups having 1 to 20 carbon atoms, or more likely is comprises the same alkoxide groups having 1 to 4 carbon atoms.

In many embodiments, the titanium alkoxide comprises the same or different alkoxide groups having 1 to 20 carbon atoms for example, the same or different methoxide, ethoxide, isopropoxide, t-butoxide, n-butoxide, n-butoxide, n-hexoxide, cyclohexide, and others that would be readily apparent to one skilled in the art.

Useful substituted or unsubstituted aryl groups in the aryloxide groups include substituted or unsubstituted carbocyclic aromatic groups having 6 or 10 carbon atoms in the aromatic ring, such as substituted or unsubstituted phenyl, naphthyl, 4-methylphenyl, phenol, 2-methoxyphenol, monophenyl ether, monobenzyl ether, and similar groups. Useful aryloxide groups include substituted or unsubstituted phenoxide groups.

The titanium alkoxide and titanium aryloxide compounds useful in this invention can further comprise one or more “secondary” metals that are selected from Group 2 to Group 12 metals in Rows 4 and 5 of the Periodic Table. However, titanium comprises at least 50 mol % or more likely at least 80 mol %, of the total moles of metals in the compounds. Particularly useful secondary metals include but are not limited to, barium, strontium, zirconium, nickel, copper, zinc, palladium, silver, lanthanum, and combinations thereof (two or more metals).

Particularly useful combinations of metals that provide the desired metal alkoxides and metal aryloxides include but are not limited to, barium with titanium, strontium with titanium, barium and titanium with zirconium, and barium and strontium with titanium as long as titanium comprises at least 50 mol % of the total moles of metals.

The titanium alkoxides and titanium aryloxides useful in the practice of the present invention can be prepared in any suitable manner or obtained from various commercial sources.

The alkoxide and aryloxide groups can also be substituted with one or more substituents that do not interfere with the formation of the titania sol-gel after exposure to the desired radiation. Particularly useful titanium alkoxides are titanium(IV) isopropoxide and titanium(IV) n-butoxide. In most embodiments, the titanium alkoxide comprises the same alkoxide groups.

One or more titanium alkoxides are present in the titania precursor composition in an amount of at least 5 weight % and up to and including 50 weight %, or typically of at least 10 weight % and up to and including 20 weight %.

Component (b): R(O)ₘCOCH₂CO(O)ₙR′ Compounds

A second essential component for use in the present invention is an R(O)ₘCOCH₂CO(O)ₙR′ compound wherein R and R′ are independently alkyl having at least 1 carbon atom, and typically up to and including 4 carbon atoms. These compounds include β-diketones and acetoacetone and its derivatives.

In such compounds, R and R′ are independently alkyl groups having 1 to 20 carbon atoms (branched or linear) including but not limited to methyl, ethyl, n-propyl, isopropyl, n-butyl, 2-isobutyl, t-butyl, n-hexyl, dodecyl, and other groups that would be readily apparent to one skilled in the art. As used for the components (a) and (b), “alkyl” group also includes cycloalkyl groups having at least 5 carbon atoms in the saturated carbocyclic ring. All of the R and R′ groups can also be substituted with one or more substituents that will not interfere with the formation of the titania sol-gel upon suitable irradiation.

In many useful embodiments, R and R′ are independently alkyl groups having 1 to 4 carbon atoms (linear or branched).

In addition, in such compounds, m and n are independently 0 or 1, and in many useful embodiments, at least one of m and n is 1. For example, alkyl acetoacetates are useful wherein the alkyl group (linear or branched) has 1 to 4 carbon atoms.

When considering the first two essential components, it is generally desirable that the molar ratio of the titanium alkoxide or titanium aryloxide to the R(O)ₘCOCH₂CO(O)ₙR′ compound is from 1:0.5 to and including 1:4, or more typically from 1:1 to and including 1:2.

Useful R(O)ₘCOCH₂CO(O)ₙR′ compounds can be obtained from various commercial sources or prepared using known chemical synthetic methods.

Component (c): Water

Water is a third essential component for the titania precursor composition. It is not merely a solvent for the composition but is also a reactant and it is desirable that it be present in a suitable molar amount so that the titania sol-gel can be formed on a substrate upon drying. In general, the molar ratio of the titanium alkoxide or titanium aryloxide to water is from 1:1 to and including 1:4, or more typically from 1:2 to and including 1:3. Tap water can be used, but it is preferable to use distilled or deionized water to minimize unwanted reactions of impurities in the resulting titania sol-gel and conductive metal patterns.

Component (d): Strong Acid or Source of Halogen

The fourth essential component of the titania precursor composition is either a strong acid having a pKₐ less than 1 or even less than 0 (as measured in water), or a source of a halogen, such as a compound that can be hydrolyzed to provide a halogen.

Useful strong acids for component (d) include but are not limited to, hydrochloric acid, hydrobromic acid, nitric acid, hydroiodic acid, sulfuric acid, perchloric acid, and chloric acid. Hydrochloric acid is particularly useful. Mixtures of such strong acids can also be used if desired and chemically possible.

Component (d) compounds that can be hydrolyzed to provide a halogen such as chlorine, bromine, or iodine are useful. Various compounds of this type include but are not limited to, are halosilanes that comprise a hydrolyzable halogen group. Examples of such compounds include but are not limited to, a silane comprising a hydrolyzable halogen group such as polychlorosilanes, polybromosilanes, trichlorosilanes, and dichlorosilanes.

Particularly useful compounds with hydrolyzable groups include fluorinated or non-fluorinated silicon oxide precursors that can be defined by the formulas SiR″X₃ or SiX₄, wherein R″ is hydrogen or a substituted or unsubstituted alkyl group (linear or branched) having 1 to 20 carbon atoms, a substituted or unsubstituted alkene group (linear or branched) having 1 to 20 carbon atoms, or a substituted or unsubstituted aryl group having 6 or 10 carbon atoms in the aromatic ring, and X is a halogen. For example, such compounds can be a hydrolyzable fluoroalkylsilane or a hydrolyzable polyhalosilane, each having at least three hydrolyzable halogen (X) groups.

Other useful compounds include trichlorosilanes such as benzyltrichlorosilane, allyltrichlorosilane, and phenyltrichlorosilane.

Hydrolyzable fluoroalkylsilanes useful in the practice of this invention are silicon oxide precursors having three hydrolyzable halogens and an uncharged non-hydrolyzable fluorinated alkyl substituent attached to the silicon atom.

For example, the hydrolyzable fluoroalkylsilane can be represented by the formula:

R²—R³—Si(X)₃

wherein R² is a fluoroalkyl group, R³ is an aliphatic linking group connecting the fluoroalkyl group to Si, and X is a hydrolyzable halogen as described above. More particularly, R³ can be represented by the formulae —(CH₂)ₙ—, —(CH₂)ₙCH—, and —(CH₂)ₙC—, depending upon the degree of branching, wherein n in these formulae is at least 1 and up to and including 3.

Non-hydrolyzable fluorinated alkyl substituents include but are not limited to, 3,3,3-trifluoropropyl, tridecafluoro-1,1,2,2-tetrahydrooctyl, heptadecafluoro-1,1,2,2-tetrahydrodecyl, nonafluorohexyl, and 5,5,6,6,7,7,8,8,9,9,10,10-tridecafluoro-2-(tridecafluorohexyl).

Typical hydrolyzable fluoroalkylsilanes useful in the practice of this invention include but are not limited to, fluoroalkyl alkoxysilanes, such as, 3,3,3-trifluoropropyltriethoxysilane, tridecafluoro-1,1,2,2-tetrahydrooctyltri-ethoxysilane, (heptadecafluoro-1,1,2,2-tetrahydrodecyl)triethoxysilane, (heptadecafluoro-1,1,2,2-tetrahydrodecyl)trimethoxysilane, nonafluorohexyl-triethoxysilane, nonafluorohexyltrimethoxysilane, (tridecafluoro-1,1,2,2-tetrahydrooctyl)trimethoxysilane, 5,5,6,6,7,7,8,8,9,9,10,10-tridecafluoro-2-(tridecafluorohexyl)decyltrichlorosilane and fluoroalkylchlorosilanes, such as (perfluorodecyl)ethyltrichlorosilane, (heptadecafluoro-1,1,2,2-tetrahydrodecyl)-trichlorosilane, nonafluorohexyltrichlorosilane, and (tridecafluoro-1,1,2,2-tetrahydrooctyl)trichlorosilane.

Component (d) can be present in the titania precursor composition such that the molar ratio of the titanium alkoxide or titanium aryloxide to a compound (d) is from 1:0.5 to and including 1:005, or more typically 1:0.1 to and including 1:0.05.

It is particularly useful that the source of halogen is a silane that comprises a hydrolyzable halogen group, and the molar ratio of the titanium alkoxide to the source of halogen is from 1:1 to and including 1:0.001, or typically from 1:0.1 to and including 1:0.05.

Hydrolyzable alkoxides are not useful in the practice of this invention. Such non-useful compounds include but are not limited to, silicon alkoxides such as tetramethoxysilane and tetraethoxysilane.

Component (e Water-Miscible Organic Solvents

The fifth essential component includes one or more water-miscible organic solvents that will provide desired coating or application characteristics and are sufficiently miscible with water that is the predominant (more than 50 weight % of all solvents) solvent in the titania precursor composition, and does not interfere with the formation of the titania sol-gel on a substrate. Examples of useful water-miscible organic solvents include but are not limited to, alcohols (such as methanol, ethanol, isopropyl alcohol, n-butanol, and sec-butanol), ethers (such as tetrahydrofuran and dioxane), and amides (such as formamide and N,N-dimethylformamide).

As described herein, the respective amounts of the five essential components (a) through (e) are formulated in the titania precursor composition so that when applied to a substrate and dried, the titania precursor composition provides a desired titania sol-gel.

Particularly useful embodiments of titania precursor compositions comprise a molar ratio of the titanium alkoxide to the R(O)ₘCOCH₂CO(O)ₙR′ component (b) is from 1:0.5 to and including 1:4, and the component (d) is a silane comprising a hydrolyzable group, wherein the molar ratio of the titanium alkoxide to component (d) is from 1:1 to and including 1:0.01.

For example, the titania precursor composition can comprise titanium(IV) isopropoxide, ethyl acetoacetate, water, isopropanol, and a trichloro silane in sufficient molar amounts to provide a titania sol-gel on the substrate when dried.

The titania precursor compositions can further include various addenda that are optional but that may facilitate coating or application of a layer onto a substrate, or provide other formulation or coating properties. Such optional addenda include but are not limited to, binders, humectants, viscosity agents, dyes, pigments, dispersing agents, surfactants, thickening agents, photosensitizers, and adhesion promoters, as long as they do not interfere with the formation of the gel network film.

One or more organic polymers can be present in the titania precursor composition in an amount of up to and including 5 weight % based on the total titania precursor composition weight (including water and water-miscible organic solvents). Such organic polymers should be soluble or dispersible in the water-miscible organic solvents. The organic polymers can be present in order to prevent cracks and provide flexibility in the titania sol-gel. Representative organic polymers include but are not limited to, poly(vinyl butyral), poly(methyl methacrylate), poly(hydroxyethyl methacrylate), cellulose acetate butyrate, and poly(vinyl pyrrolidone).

In some embodiments, the titania precursor composition consists essentially of the five essential components (a) through (e) described above in sufficient amounts to provide a layer of a titania sol-gel on a substrate, when dried. Any additional components in such embodiments would not be essential to form the dry titania sol-gel on a substrate.

### Articles

To form a uniform titania sol-gel layer, the titania precursor composition described herein can be applied to a suitable substrate using any suitable method including but not limited to, spin coating, rod coating, bead coating, blade coating, curtain coating, or spray coating, from a suitable reservoir to form a layer of titania sol-gel when applied and dried on the substrate. Useful substrates can be chosen for a particular use or method as long as the substrate material will not be degraded by the titania precursor composition or any procedures to which the resulting precursor and intermediate articles are subjected during the methods of this invention. The titania precursor composition can be applied multiple times if desired to obtain a thicker coating of the titania precursor composition, and dried between each coating or dried only after the last application. Water-miscible organic solvents and residual water can be removed from the applied titania precursor composition using any suitable drying technique and conditions so that reactions occur within the titania precursor composition to form the desired titania sol-gel.

Suitable drying conditions, equipment, and procedures include but are not limited to, simple evaporation, using convective air flow at room temperature or an elevated temperature, or by applying infrared radiation or microwave radiation.

The titania precursor composition, upon drying, is provided as the outermost substance disposed on the substrate, meaning that no protective layer or overcoat is applied or needed over the titania precursor composition in the articles of the present invention. This outermost titania precursor composition is thus in the form of an outermost uniform layer.

Useful substrates can be composed of glass, quartz, and ceramics as well as a wide variety of flexible materials such as cellulosic papers and polyesters including poly(ethylene terephthalate) and poly(ethylene naphthalate), polycarbonates, polyamides, poly(meth)acrylates, and polyolefins. Useful flexible polymeric substrates can be formed by casting or extrusion methods. Laminates of various substrate materials can also be put together to form a composite substrate. Any of the substrates can be treated to improve adhesion using for example corona discharge, oxygen plasma, ozone or chemical treatments. The substrates can be of any suitable dry thickness including but not limited to at least 10 μm and up to and including 10 mm, depending upon the intended use of the resulting articles.

Particularly useful flexible substrates are composed of poly(ethylene terephthalate) such as biaxially oriented poly(ethylene terephthalate) (PET) films that have broad uses in the electronics market. These PET films, ranging in dry thickness of at least 50 μm and up to and including 200 μm, can also comprise, on at least one side, a polymeric primer layer (also known as a subbing layer, adhesive layer, or binder layer) that can be added prior to or after film stretching. Such polymeric primer layers can comprise poly(acrylonitrile-co-vinylidene chloride-co-acrylic acid), poly(methyl acrylate-co-vinylidene chloride-co-itaconic acid), poly(glycidyl methacrylate-co-butyl acrylate), or various water-dispersible polyesters, water-dispersible polyurethanes, or water-dispersible polyacrylic resins, as well as sub-micrometer silica particles. The dry thickness of the primer layer can be at least 0.1 μm and up to and including 1 μm.

Thus, with the uniform application of the described titania precursor composition comprising components (a) through (e) in molar amounts as described above, to a suitable substrate, with or without appropriate drying, the present invention provides a precursor article comprising a substrate and having disposed thereon a uniform layer of a titania precursor composition (before drying) or a layer of a titania sol-gel that has been formed upon drying of the titania precursor composition. Such coatings are generally uniform in composition and dry thickness.

In general, the final dry layer of titania sol-gel can have an average dry thickness of at least 10 nm and up to and including 10 mm, with a dry thickness of at least 0.1 μm and up to and including 100 μm being more useful. The average dry titania sol-gel thickness can be determined by measuring the dry titania sol-gel thickness in at least 10 different places within a 10 cm by 10 cm square of the dry layer using an electron microscope or other suitable diagnostic device.

### Uses of Reactive Compositions

The titania precursor compositions described herein can be used to form surface conductive metal patterns for various purposes as described above. The following discussion provides some details about representative electroless plating methods in which the titania precursor compositions can be used to form titania sol-gels as an uniform layer.

In these conductive metal patterning plating methods, each aqueous-based “processing” solution, dispersion, or bath (for example, solutions containing electroless seed metal ions, solutions for electroless plating, “fixing” or chelating solutions, as well as rinsing solutions) used at various points can be specifically designed with essential components as well as optional addenda that would be readily apparent to one skilled in the art. For example, one or more of those aqueous-based processing solutions can include such addenda as surfactants, anti-coagulants, anti-corrosion agents, anti-foamants, buffers, pH modifiers, biocides, fungicides, and preservatives.

A method of this invention can be carried out using a uniform layer of a titania precursor composition on a substrate, which titania precursor composition is dried to form an article with a uniform layer of titania sol-gel on the substrate instead of a pattern of the titania sol-gel.

Thus, precursor articles can comprise a substrate and a provided thereon a uniform layer of a titania sol-gel that has been formed upon drying a uniform layer of a titania precursor composition on a substrate, wherein the molar amounts of (a) through (e) of the titania precursor composition are sufficient, upon drying, to form the uniform layer of a titania sol-gel on the substrate. The uniform layer of titania precursor composition can be provided on the substrate in any desirable coating procedure as described above. Upon drying, the titania precursor composition reacts and forms the desired uniform layer of titania sol-gel. Suitable drying procedures and equipment are described above.

The resulting uniform layer of titania sol-gel can then be contacted with electroless metal ions to provide a uniform layer of electroless seed metal ions within (generally deposited uniformly) the uniform layer of titania sol-gel on the substrate. This is generally achieved by contacting the precursor article with an aqueous-based solution or dispersion of electroless seed metal ions. There are various ways that this contacting can be carried out. Typically, the entire precursor article is immersed within a dilute aqueous-based solution, bath, or dispersion of the electroless seed metal ions for a sufficient time to coordinate, adhere, or deposit the optimum number of electroless seed metal ions within the uniform layer of titania sol-gel. For example, this contact with the electroless seed metal ions can be carried out for at least 1 second and up to and including 30 minutes, at room temperature (about 20° C.) or at a higher temperature of up to and including 95° C. The time and temperature for this contact can be optimized for a given titania precursor composition and electroless seed metal ions that are to be used in the method.

Representative electroless seed metal ions that can be used in these procedures are selected from the group consisting of silver ions, platinum ions, palladium ions, gold ions, tin ions, rhodium ions, iridium ions, nickel ions, and copper ions, and particularly silver ions and palladium ions. Most noble metal ions can serve as electroless seed metal ions in the practice of the present invention. These electroless seed metal ions can be provided in the form of a suitable metal salt or metal-ligand complex (that can have an overall positive, negative, or neutral charge). Useful materials of this type include but are not limited to, metal salts and metal-ligand complexes of nitrates, halides, acetates, cyanides, thiocyanates, amines, nitriles, and sulfates. Thus, the electroless seed metal ions can be provided from simple salts or in the form of metal-ligand complexes. The amount of metal salts or metal-ligand complexes present in the aqueous-based solution would be readily apparent to one skilled in the art and can be optimized for a particular reactive composition and exposure procedure. For example, the metal salts or metal-ligand complexes can be present in the aqueous-based solution in an amount sufficient to provide at least 0.00001 molar and up to and including 2 molar of the desired electroless metal ions.

The contact with the electroless seed metal ions produces an intermediate article comprising a substrate and having disposed thereon a uniform layer of a titania sol-gel, which uniform layer also comprises electroless seed metal ions within (generally deposited) the titania sol-gel that has been formed from a titania precursor composition comprising components (a) to (e) in molar amounts all described above, on the substrate.

After the requisite time to deposit the electroless seed metal ions within with the uniform layer of titania sol-gel, the resulting intermediate article can be rinsed with distilled or deionized water or another aqueous-based solution for a suitable time and at a suitable temperature, for example usually room temperature or slightly higher to remove any non-deposited electroless seed metal ions.

The resulting intermediate article can then be imagewise exposed to radiation having a λₘₐₓ of at least 150 nm and up to and including 380 nm or to radiation having a λₘₐₓ of at least 150 nm and up to and including 365 nm, to reduce the electroless seed metal ions, thereby forming a pattern of exposed regions and non-exposed regions in the uniform layer of the titania sol-gel on the substrate. The exposed regions contain electroless seed metal nuclei within the titania sol-gel on the substrate, corresponding to the electroless seed metal ions (that is, the same metal is present in as metal ions as metal nuclei). The excitation of the electrons in the titania sol-gel leads to an electron transfer to the metal ions adsorbed on the surface, leading to the reduction of the electroless seed metal ions during the imagewise exposure. The non-exposed regions on the substrate comprise electroless seed metal ions deposited in the titania sol-gel, but comprise very little or no electroless seed metal nuclei.

This imagewise exposure can be provided with any suitable exposing source or device that provides the desired radiation including but not limited to, various arc lamps and LED sources. The particular exposing source can be chosen depending upon the absorption characteristics of the titania precursor composition used. The imagewise exposing radiation can be projected through lenses or a mask element that can be in physical contact or in proximity with the outer surface of the intermediate article. Exposure time can range from a fraction (0.1) of a second and up to and including 25 minutes depending upon the intensity of the radiation source and the titania precursor composition. Suitable masks can be obtained by known methods including but not limited to photolithographic methods, flexographic methods, or vacuum deposition of a chrome mask onto a suitable substrate such as quartz or high quality optical glass followed by photolithographic patterning.

At this point, the method of this invention has provided another intermediate article comprising a substrate and having thereon a uniform layer of a titania sol-gel, the uniform layer comprising exposed regions and non-exposed regions, the exposed regions comprising a pattern of electroless seed metal nuclei within (generally deposited within) the titania sol-gel, and non-exposed regions comprising electroless seed metal ions within (generally deposited within) the titania sol-gel. The titania sol-gel has been prepared by drying a titania precursor composition described herein comprising the described (a) through (e) components in the desired amounts on a substrate.

After the imagewise exposure, most or all of the non-reduced electroless seed metal ions in the non-exposed regions of the uniform layer of titania sol-gel on the substrate can be removed by using compounds that will complex or chelate with the non-reduced electroless seed metal ions strong enough to “pull them off” or remove them from the surface of or from within the titania sol-gel. This treatment leaves only the titania sol-gel in those non-exposed regions. The electroless seed metal nuclei within the titania sol-gel remain in the exposed regions of the titania sol-gel disposed on the substrate.

This removal process can be considered a “fixing” procedure similar to photographic fixing where metal ions are dissolved or complexed and removed from the non-exposed regions. In general, metal ion complexation can be carried out using a suitable chelating or complexing agent that has an ability to form two or more coordinate bonds with the metal ions to be removed. Generally, useful chelating agents contain two or more functional groups in the molecule that can bind with the metal ions. These functional groups are typically organic polydentate ligands that contain carboxylic acids, amines, ethers, or thiols. Some examples of such chelating agents include but are not limited to, ethylenediaminetetraacetic acid, ethylenediaminetriacetic acid, citric acid, dimercaprol, and crown ethers. Other chelating agents can contain heterocycles such as porphyrins and phenanthrolines. Another type of “fixer” that can be used is an inorganic salt that contain anions or ligands with good affinity to the unexposed metal ions. Such fixers include but are not limited to, sodium thiosulfate, iron oxalate, and iron lactate.

The desired chelating or complexing agents can be provided in a suitable aqueous-based solution or dispersion in which one or more chelating or complexing agents are present in an amount sufficient to remove the electroless seed metal ions, and in most situations, this amount can be at least 0.01 weight % and up to and including 20 weight %.

At this point, the method of this invention has provided still another intermediate article comprising a substrate and having disposed thereon a uniform layer of a titania sol-gel prepared from a titania precursor composition as described herein, which uniform layer of titania sol-gel comprises exposed regions comprising electroless seed metal nuclei within (generally deposited or complexed within) the titania sol-gel, and non-exposed regions comprising only the titania sol-gel and substantially no electroless seed metal ions or corresponding electroless seed metal nuclei. By “substantially”, it is meant that at least 95 weight % of the originally deposited electroless seed metal ions have been removed from the non-exposed regions of the uniform layer of titania sol-gel.

This intermediate article can be immediately immersed in an aqueous-based electroless metal plating bath or solution, or the intermediate article can be stored with just the catalytic pattern comprising corresponding electroless seed metal nuclei for use at a later time.

The intermediate article can be contacted with an electroless plating metal that is the same as or different from the corresponding electroless seed metal nuclei. In most embodiments, the electroless plating metal is a different metal from the corresponding electroless seed metal nuclei.

Any metal that will likely electrolessly “plate” on the pattern (titania sol-gel layer exposed regions) of corresponding electroless seed metal nuclei can be used at this point, but in most embodiments, the electroless plating metal can be for example copper(II), silver(I), gold(IV), palladium(II), platinum(II), nickel(II), chromium(II), and combinations thereof. Copper(II), silver(I), and nickel(II) are particularly useful electroless plating metals.

The one or more electroless plating metals can be present in the aqueous-based electroless plating bath or solution in an amount of at least 0.01 weight % and up to and including 20 weight % based on total solution weight.

Electroless plating can be carried out using known temperature and time conditions, as such conditions are well known in various textbooks and scientific literature. It is also known to include various additives such as metal complexing agents or stabilizing agents in the aqueous-based electroless plating solutions. Variations in time and temperature can be used to change the metal electroless plating thickness or the metal electroless plating deposition rate.

A useful aqueous-based electroless plating solution or bath is an electroless copper(II) plating bath that contains formaldehyde as a reducing agent. Ethylenediaminetetraacetic acid (EDTA) or salts thereof can be present as a copper complexing agent. For example, copper electroless plating can be carried out at room temperature for several seconds and up to several hours depending upon the desired deposition rate and plating rate and plating metal thickness.

Other useful aqueous-based electroless plating solutions or baths comprise silver(I) with EDTA and sodium tartrate, silver(I) with ammonia and glucose, copper(II) with EDTA and dimethylamineborane, copper(II) with citrate and hypophosphite, nickel(II) with lactic acid, acetic acid, and a hypophosphite, and other industry standard aqueous-based electroless baths or solutions such as those described by Mallory et al. in Electroless Plating: Fundamentals and Applications 1990.

After the electroless plating procedure, the resulting product article is removed from the aqueous-based electroless plating bath or solution and can again be washed using distilled water or deionized water or another aqueous-based solution to remove any residual electroless plating chemistry. At this point, the pattern of electrolessly plated metal is generally stable and can be used for its intended purpose.

To change the surface of the pattern of electroless plated metal for visual or durability reasons, it is possible that a variety of post-treatments can be employed including surface plating of still at least another (third or more) metal such as nickel or silver on the electrolessly plated metal (this procedure is sometimes known as “capping”), or the creation of a metal oxide, metal sulfide, or a metal selenide layer that is adequate to change the surface color and scattering properties without reducing the conductivity of the electrolessly plated (second) metal. Depending upon the metals used in the various capping procedures of the method, it may be desirable to treat the electrolessly plated metal with a metal catalyst (additional electroless seed metal ions) to facilitate deposition of additional metals. Depending upon the metals used in the various capping procedures of the method, it may be desirable to treat the electrolessly plated metal with electroless seed metal ions (catalyst) in an aqueous-based seed metal catalyst solution to facilitate deposition of additional metals.

This method therefore provides a product article comprising a substrate and having disposed thereon a uniform layer of a titania sol-gel, the layer comprising exposed regions comprising electrolessly plated metal within the uniform layer of the titania sol-gel, and non-exposed regions comprising only the titania sol-gel. The titania sol-gel has been formed upon drying a uniform layer of titania precursor composition described herein comprising (a) through (e) components in desired amounts sufficient to form a pattern of a titania sol-gel upon drying on the substrate.

The present invention provides at least the following embodiments and combinations thereof, but other combinations of features are considered to be within the present invention as a skilled artisan would appreciate from the teaching of this disclosure:

1. A method for forming a conductive metal pattern, comprising:

providing a layer of a titania sol-gel formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate,

contacting the layer of titania sol-gel with electroless seed metal ions to provide a layer of electroless seed metal ions within the layer of titania sol-gel on the substrate,

imagewise exposing the layer of electroless seed metal ions deposited within the layer of titania sol-gel to form non-exposed regions and exposed regions, the non-exposed regions comprising non-exposed electroless seed metal ions within the titania sol-gel, and the exposed regions comprising electroless seed metal nuclei within the titania sol-gel,

removing the electroless seed metal ions in the non-exposed regions, and

electrolessly plating the electroless seed metal nuclei within the titania sol-gel in the exposed regions using a metal that is the same as or different from the electroless seed metal nuclei.

2. The method of embodiment 1, comprising exposing the pattern of electroless seed metal ions with radiation having a λₘₐₓ of at least 150 nm and up to and including 380 nm.

3. The method of embodiment 1 or 2, comprising contacting the electroless seed metal nuclei within the titania sol-gel in the exposed regions with electroless seed metal ions selected from the group consisting of silver ions and palladium ions.

4. The method of any of embodiments 1 to 3, wherein the electroless plating metal is selected from the group consisting of copper(II), silver(I), gold(IV), palladium(II), platinum(II), nickel(II), chromium(II), and combinations thereof.

5. The method of any of embodiments 1 to 4, comprising removing the electroless seed metal ions within the titania sol-gel in the non-exposed regions contacting the electroless seed metal ions with a chelating agent having a Kₛₚ strong enough to remove the electroless seed metal ions from the titania sol-gel layer.

6. A precursor article provided during the practice of any of embodiments 1 to 5, the precursor article comprising a substrate having a layer of a titania sol-gel that has been formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

7. An intermediate article provided during the practice of any of embodiments 1 to 5, the intermediate article comprising a substrate and having disposed thereon a layer of titania sol-gel, the layer of titania sol-gel comprising electroless seed metal ions within the titania sol-gel that has been formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

8. An intermediate article provided during the practice of any of embodiments 1 to 5, the intermediate article comprising a substrate and having disposed thereon a layer of a titania sol-gel, the layer of titania sol-gel comprising exposed regions comprising electroless seed metal nuclei within the titania sol-gel, and non-exposed regions comprising corresponding electroless seed metal ions within the titania sol-gel,

wherein the layer of titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

9. An intermediate article provided during the practice of any of embodiments 1 to 5, the intermediate article comprising a substrate and having disposed thereon a layer of a titania sol-gel, the layer of titania sol-gel comprising exposed regions comprising electroless seed metal nuclei within the titania sol-gel, and non-exposed regions comprising only the titania sol-gel,

wherein the layer of titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

10. A product article as provided by any of embodiments 1 to 5, the product article comprising a substrate and having disposed thereon a layer of a titania sol-gel, the layer of titania sol-gel comprising exposed regions comprising electrolessly plated metal within the titania sol-gel, and non-exposed regions comprising only the titania sol-gel,

wherein the titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

11. Any of embodiments 1 to 10, wherein the titanium alkoxide comprises the same or different alkoxide groups having 1 to 20 carbon atoms and the titanium aryloxide is a titanium phenoxide.

12. Any of embodiments 1 to 11, wherein R and R′ are independently alkyl groups having 1 to 20 carbon atoms.

13. Any of embodiments 1 to 12, wherein the source of halogen is a silane comprising a hydrolyzable halogen group.

14. Any of embodiments 1 to 11, wherein the acid having a pKₐ less than 1 is selected from hydrochloric acid, hydrobromic acid, nitric acid, hydroiodic acid, sulfuric acid, perchloric acid, and chloric acid.

15. Any of embodiments 1 to 14, wherein the molar ratio of the titanium alkoxide or titanium aryloxide to the R(O)ₘCOCH₂CO(O)ₙR′ compound is from 1:0.5 to and including 1:4.

16. Any of embodiments 1 to 13 or 15, wherein the source of halogen is a silane that comprises a hydrolyzable halogen group, and the molar ratio of the titanium alkoxide or titanium aryloxide to the source of halogen is from 1:1 to and including 1:0.01.

17. Any of embodiments 1 to 16, wherein the titania precursor composition comprises titanium(IV) isopropoxide, ethyl acetoacetate, water, and either a trichloro silane or hydrochloric acid in sufficient molar amounts to provide a titania sol-gel upon drying on the substrate.

18. Any of embodiments 1 to 17, wherein the titania precursor composition further comprises an organic polymer binder.

The following Examples are provided to illustrate the practice of this invention and are not meant to be limiting in any manner.

### Composition Invention Examples 1-3 and Composition Comparative Examples 1-2

### Use of Silanes as Source of Halogens

Several titania precursor compositions were prepared in the following manner using the following components:

Component (a) titanium (IV) isopropoxide (1.33 ml) and component (e) isopropyl alcohol (IPA, 4 ml) were combined as a stirred solution in a capped container. Component (b) ethyl acetoacetate (0.57 ml) was then added to the stirred solution. After 3 hours of stirring, component (c) water (160 μl) in component (e) IPA (4 ml) was added to the solution and further stirring was carried out for 15 minutes. A component (d) silane within the present invention or outside the present invention (TABLE I below) was added at a 1:0.05 mole ratio of component (a) to component (d) and the resulting titania precursor composition was stirred overnight to obtain the expected invention and comparative titania precursor composition. The length of the stability of the titania precursor compositions (that is, without gelling or precipitation) are also shown below in TABLE I.

TABLE I

| Titania | | | |
|---|---|---|---|
| Precursor | | Amount | |
| Composition | Component (d) Silanes | (μl) | Stability |
| Invention | (Heptadecafluoro-1,1,2,2- | 77 | >7 months |
| Example 1 | tetrahydrodecyl)trichlorosilane | | |
| Comparative | (3-Aminopropyl)triethoxysilane | 53 | Only |
| Example 1 | | | overnight |
| Comparative | (3- | 50 | Only |
| Example 2 | Glycidoxypropyl)trimethoxysilane | | overnight |
| Invention | [11-(2-Bromo-2-methyl)propionyl- | 100 | >3 months |
| Example 2 | oxy]undecyltrichlorosilane | | |
| Invention | (3-Methacryloxypropyl)trichloro- | 59 | >6 months |
| Example 3 | silane | | |

It is apparent from these results that the titania precursor compositions used in this invention are considerably more stable than the titania precursor compositions that are outside the scope of the present invention. This enables a user to prepare the titania precursor composition according to the present invention and store it for use some time later without significant loss in the ability to prepare a suitable titania sol-gel. In other words, there are minimal premature reactions in the titania precursor composition used in the present invention.

### Composition Invention Example 4 and Composition Comparative Example 3

### Use of Acids Having pKa Less than 1

Two titania precursor compositions of this inventions were prepared using component (a) titanium (IV) isopropoxide (1.33 ml) and component (e) isopropyl alcohol (IPA, 4 ml) were combined as a stirred solution in a capped container. Component (b) ethyl acetoacetate (0.57 ml) was then added to the stirred solution. After 3 hours of stirring, component (d) source of an acid (TABLE II below) was introduced to the solution. After thoroughly mixing the solution, component (c) water (160 μl) in component (e) IPA (4 ml) was added to the solution and stirring was continued overnight to provide the expected invention titania precursor compositions. The stability of the titania precursor compositions is also shown in TABLE II below.

TABLE II

| Titania | | | |
|---|---|---|---|
| Precursor | Component (d) | Amount | |
| Composition | Source of Acid | (μl) | Stability |
| Comparative | Acetic acid | 14 | Only |
| Example 3 | | | overnight |
| Invention | Hydrochloric | 14 | >5 months |
| Example 4 | acid | | |

It is apparent from these results that the titania precursor compositions used in the present invention are considerably more stable than the titania precursor compositions that are outside the scope of the present invention. This enables a user to prepare the titania precursor composition according to the present invention and store it for use some time later without significant loss in the ability to prepare a suitable titania sol-gel. In other words, there are minimal premature reactions in the titania precursor composition used in the present invention. Moreover, these results demonstrate that the present invention can be used with strong acids as well as halogen-containing silanes as component (d).

Preparation of the Electroless Copper(II) Plating Bath:

Copper sulfate pentahydrate (1.80 g), tetrasodium ethylenediaminetetracetic acid tetrahydrate (6.25 g), and potassium ferrocyanide trihydrate (0.005 g) were placed in a beaker and dissolved in water (80 ml). Formaldehyde (37% solution in water, 2.25 g) was then added to the solution. After mixing, the solution pH was adjusted to 12.8 with 45% KOH solution to provide an electroless copper(II) plating bath.

### Electroless Metal Plating Using a Patterned Titania Sol-Gel:

Forming a Pattern of Electroless Seed Metal Ions:

Precursor articles containing a uniform layer of a titania sol-gel were provided from a uniform layer of various titania precursor compositions. Each precursor article containing a uniform layer of titania sol-gel was soaked in an aqueous electroless seed silver solution containing 0.4 molar silver nitrate for 10 seconds to provide a uniform layer of electroless seed silver ions in the uniform layer of titania sol-gel, and the resulting intermediate article was then rinsed well with running deionized water to remove any non-adsorbed electroless seed silver ions. The resulting intermediate articles were then dried with air and were sandwiched between a glass slide and a chrome mask having the target patterns. Each intermediate article was then exposed to UV radiation through the mask for 60 seconds to form a pattern of reduced electroless seed silver ions, that is, a pattern of electroless seed silver nuclei in the layer of titania sol gel.

After the UV exposure, each exposed intermediate article was then placed in a 0.1 molar solution of tetrasodium ethylenediaminetetracetic acid tetrahydrate for 5 minutes to desorb or remove the non-reduced silver ions from the non-exposed regions of the uniform layer of titania sol-gel on the PET film substrate. Each resulting intermediate article was then rinsed with running deionized water and dried.

Each intermediate article having a pattern of electroless seed silver ions in the uniform layer of titania sol-gel was soaked in the electroless copper(II) plating bath for a certain period of time to electrolessly plate copper metal onto the pattern of electroless seed silver ions in the uniform layer of titania sol-gel. After each of these articles was taken out of the electroless copper(II) plating bath, it was rinsed well with running deionized water and dried with air.

### Use Comparative Example 1

Titanium (IV) isopropoxide (100 μl) was mixed with 1-butanol (1.9 ml). This metal alkoxide solution was coated onto a poly(ethylene terephthalate) (PET) film that had been coated with a copolymer subbing layer derived from acrylonitrile, vinyl chloride, and acrylic acid. The resulting substrate with the uniform titanium alkoxide layer was heated to 110° C. for 15 minutes and was then imagewise exposed with UV radiation through a photomask for one minute. The substrate surface was then soaked in 0.4 molar silver(I) nitrate solution for 10 seconds. The soaked surface was rinsed with water and dried, and then immersed in the electroless copper(II) plating bath solution described above for 2 minutes. The results are shown below in TABLE IV.

### Use Comparative Example 2

The same titanium alkoxide solution described above in Use Comparative Example 1 was coated onto a glass substrate, dried under ambient conditions for 15 minutes, and heated to 150° C. for 15 minutes. The uniform layer of the titanium alkoxide was then imagewise exposed with UV radiation through a photomask for 90 seconds and then soaked in an electroless seed silver ion solution containing 0.4 molar silver(I) nitrate for 10 seconds. The uniform alkoxide metal layer was rinsed with water, dried, and then immersed in the electroless copper(II) plating bath for 2 minutes. The results are shown below in TABLE IV.

### Use Comparative Example 3

The same titanium alkoxide solution and procedures described above for Use Comparative Example 1 were used. The uniform titanium alkoxide layer was imagewise exposed with UV radiation through a photomask for 15 minutes and was immersed in an electroless seed palladium(I) chloride bath (25 mg of PdCl₂ in 100 ml of water and 0.25 ml of HCl) for 2 minutes. The uniform titanium alkoxide was rinsed with water, dried, and soaked in the electroless copper(II) plating bath described above for 10 minutes at 50° C. However, it was observed that the copper plated over the entire surface and not selectively on the patterned regions. The results are shown below in TABLE IV.

### Use Comparative Example 4

### Without Chelating Solution

Composition Invention Example 1 further containing 1.25% (w/v) of poly(vinyl butyral) (Butvar® 72) was coated onto a PET film substrate similar to that used in Use Comparative Example 1 described above. The uniform titania sol-gel layer was dried in ambient conditions overnight and was soaked in electroless seed silver ion solution containing 0.4 molar silver(I) nitrate for 10 seconds. The uniform titania sol-gel layer in the intermediate article was rinsed with running water. After drying, the uniform titania sol-gel layer was imagewise exposed with UV radiation through a photomask. The exposed regions turned brownish signifying the reduction of the silver ions to silver nuclei in the pattern. Without treatment with a chelating (fixing) solution, the article was then immersed in the electroless copper(II) plating bath described above for 2 minutes. The results are shown below in TABLE IV.

### Use Invention Example 1

Composition Invention Example 1 further containing 1.25% (w/v) poly(vinyl butyral) (Butvar® 72) was coated onto a PET film substrate similar to that used in Use Comparative Example 1 described above. The uniform titania sol-gel layer was dried in ambient conditions overnight and was then soaked in electroless seed silver ion solution containing 0.4 molar silver(I) nitrate for 10 seconds. The uniform titania sol-gel layer was then rinsed with running water. After drying, the uniform titania sol-gel layer was imagewise exposed with UV radiation through a photomask. The exposed regions turned brownish signifying the reduction of the silver ions to silver nuclei in the pattern. The resulting intermediate article was immersed in 0.1 molar solution of tetrasodium ethylenediaminetetraacetic acid tetrahydrate for 5 minutes to desorb or remove the non-reduced silver ions from the non-exposed regions of the uniform layer of titania sol-gel on the PET film substrate. The resulting intermediate article was rinsed with deionized water and then immersed in the electroless copper(II) plating bath described above for 2 minutes. The resistance of the product articles was determined using an ohmmeter. The “bulk” resistance was measured by placing the probes 1 cm apart on solid patches in the pattern. The resistance across the grid patterns (2 cm apart) was also measured. Conductive 5 μm grid lines were produced after copper plating. The results are shown below in TABLE IV.

### Use Invention Example 2

Composition Invention Example 4 with 1.25% (w/v) poly(vinyl butyral) (Butvar® 72) was coated onto a PET film substrate similar to that used in Use Comparative Example 1 described above. The uniform titania sol-gel layer was dried in ambient conditions overnight and was soaked in electroless seed silver ion solution containing 0.4 molar silver(I) nitrate for 10 seconds. The uniform titania sol-gel layer in the resulting intermediate article was rinsed with running water. After drying, the uniform titania sol-gel layer was imagewise exposed with UV radiation through a photomask. The exposed regions turned brownish signifying the reduction of the silver ions to silver nuclei in the pattern. The resulting intermediate article was immersed in 0.1 molar solution of tetrasodium ethylenediaminetetraacetic acid tetrahydrate for 5 minutes to desorb or remove the non-reduced silver ions from the non-exposed regions of the uniform layer of titania sol-gel on the PET film substrate. The intermediate article was rinsed with deionized water and was then immersed in the electroless copper(II) plating bath described above for 2 minutes. The resistance of the product articles was determined using an ohmmeter. The “bulk” resistance was measured by placing the probes 1 cm apart on solid patches. The resistance across the grid patterns (2 cm apart) was also measured. Conductive 5 μm grid lines were produced after copper plating. The results are shown below in TABLE IV.

TABLE IV

| | Copper selectively | Resistance (ohms) | |
|---|---|---|---|
| | plated on exposed | | Across |
| Examples | areas? | Bulk | grids |
| Use Comparative | No | Not | Not |
| Example 1 | | available | available |
| Use Comparative | No | Not | Not |
| Example 2 | | available | available |
| Use Comparative | No | Not | Not |
| Example 3 | | available | available |
| Use Comparative | No | Not | Not |
| Example 4 | | available | available |
| Use Invention | Yes | 0.8 | 99 |
| Example 1 | | | |
| Use Invention | Yes | 1.6 | 73 |
| Example 2 | | | |

These results demonstrate that electroless plating was not selective in the Comparative Examples (that is, attaching only to the desired pattern) because the metal ions that were pre-adsorbed onto the surface were also electrolessly metal plated. In contrast, the Invention Examples demonstrate that the sequence of exposure, contact with the seed metal ions, and fixing are essential to providing a selective conductive electrolessly metal plated pattern.

The invention has been described in detail with particular reference to certain preferred embodiments thereof, but it will be understood that variations and modifications can be effected within the spirit and scope of the invention.

1. A method for forming a conductive metal pattern, comprising:
providing a layer of a titania sol-gel formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate,
contacting the layer of titania sol-gel with electroless seed metal ions to provide a layer of electroless seed metal ions within the layer of titania sol-gel on the substrate,
imagewise exposing the layer of electroless seed metal ions deposited within the layer of titania sol-gel to form non-exposed regions and exposed regions, the non-exposed regions comprising non-exposed electroless seed metal ions within the titania sol-gel, and the exposed regions comprising electroless seed metal nuclei within the titania sol-gel,
removing the electroless seed metal ions in the non-exposed regions, and
electrolessly plating the electroless seed metal nuclei within the titania sol-gel in the exposed regions using a metal that is the same as or different from the electroless seed metal nuclei.

2. The method of claim 1, wherein the titanium alkoxide comprises the same or different alkoxide groups having 1 to 20 carbon atoms and the titanium aryloxide is a titanium phenoxide.

3. The method of claim 1, wherein R and R′ are independently alkyl groups having 1 to 20 carbon atoms.

4. The method of claim 1, wherein the source of halogen is a silane comprising a hydrolyzable halogen group.

5. The method of claim 1, wherein the acid having a pKₐ less than 1 is selected from hydrochloric acid, hydrobromic acid, nitric acid, hydroiodic acid, sulfuric acid, perchloric acid, and chloric acid.

6. The method of claim 1, wherein the molar ratio of the titanium alkoxide or titanium aryloxide to the R(O)ₘCOCH₂CO(O)ₙR′ compound is from 1:0.5 to and including 1:4.

7. The method of claim 1, wherein the source of halogen is a silane that comprises a hydrolyzable halogen group, and the molar ratio of the titanium alkoxide or titanium aryloxide to the source of halogen is from 1:1 to and including 1:0.01.

8. The method of claim 1, comprising exposing the pattern of electroless seed metal ions with radiation having a λₘₐₓ of at least 150 nm and up to and including 380 nm.

9. The method of claim 1, comprising contacting the electroless seed metal nuclei within the titania sol-gel in the exposed regions with electroless seed metal ions selected from the group consisting of silver ions and palladium ions.

10. The method of claim 1, wherein the electroless plating metal is selected from the group consisting of copper(II), silver(I), gold(IV), palladium(II), platinum(II), nickel(II), chromium(II), and combinations thereof.

11. The method of claim 1, wherein the titania precursor composition comprises titanium(IV) isopropoxide, ethyl acetoacetate, water, and either a trichloro silane or hydrochloric acid in sufficient molar amounts to provide a titania sol-gel upon drying on the substrate.

12. The method of claim 1, wherein the titania precursor composition further comprises an organic polymer binder.

13. The method of claim 1, comprising removing the electroless seed metal ions within the titania sol-gel in the non-exposed regions contacting the electroless seed metal ions with a chelating agent having a Kₛₚ strong enough to remove the electroless seed metal ions from the titania sol-gel layer.

14. A precursor article comprising a substrate having a layer of a titania sol-gel that has been formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

15. An intermediate article comprising a substrate and having disposed thereon a layer of titania sol-gel, the layer of titania sol-gel comprising electroless seed metal ions within the titania sol-gel that has been formed from a titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

16. An intermediate article comprising a substrate and having disposed thereon a layer of a titania sol-gel, the layer of titania sol-gel comprising exposed regions comprising electroless seed metal nuclei within the titania sol-gel, and non-exposed regions comprising corresponding electroless seed metal ions within the titania sol-gel,
wherein the layer of titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

17. An intermediate article comprising a substrate and having disposed thereon a layer of a titania sol-gel, the layer of titania sol-gel comprising exposed regions comprising electroless seed metal nuclei within the titania sol-gel, and non-exposed regions comprising only the titania sol-gel,
wherein the layer of titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.

18. A product article comprising a substrate and having disposed thereon a layer of a titania sol-gel, the layer of titania sol-gel comprising exposed regions comprising electrolessly plated metal within the titania sol-gel, and non-exposed regions comprising only the titania sol-gel,
wherein the titania sol-gel has been formed from a layer of titania precursor composition that comprises: (a) a titanium alkoxide or titanium aryloxide, (b) a R(O)ₘCOCH₂CO(O)ₙR′ compound wherein R and R′ are independently alkyl having at least 1 carbon atom, and m and n are independently 0 or 1, (c) water, (d) either an acid having a pKₐ less than 1 or a source of a halogen, and (e) a water-miscible organic solvent, on a substrate, wherein the molar amounts of (a) through (d) are sufficient to form a layer of a titania sol-gel upon drying on the substrate.
